(19) United States
(12) Patent Application Publication
(10) Pub. No.: US 2021/0026534 A1
(43) Pub. Date: Jan. 28, 2021

(54) DATA STORAGE APPARATUS, METHOD, PROGRAM, AND RECORDING MEDIUM

(71) Applicant: NEC CORPORATION, Tokyo (JP)

(72) Inventor: Shigeru KOUMOTO, Tokyo (JP)

(73) Assignee: NEC CORPORATION, Tokyo (JP)

(21) Appl. No.: 17/043,099

(22) PCT Filed: Mar. 29, 2019
(86) PCT No.: PCT/JP2019/014051

§ 371 Date: Sep. 29, 2020

(30) Foreign Application Priority Data
Mar. 30, 2018 (JP) 2018-068481

(51) Int. Cl. G06F 3/06

(52) U.S. Cl. CPC G06F 3/064; G06F 3/0653; G06F 3/0619; G06F 3/0673; G06F 3/0652

(57) ABSTRACT

A determination part of the data storage apparatus performs control such that when at least a part of a first data block stored in a first storage part satisfies a first criterion, the first data block and a predetermined number of data blocks after the first data block in the first storage part are forwarded to the second storage part for storage, and when there is data that satisfies a second criterion from the first to the predetermined number data blocks, the first storage part continue to store data blocks following the data block corresponding to the predetermined number and stored in the first storage part in the second storage part, while when there is no data that satisfies the predetermined second criterion, the first storage part is caused to stop storing a data block stored in the first storage part in the second storage part.

### CROSS REFERENCE TO RELATED APPLICATIONS

This application is a National Stage of International Application No. PCT/JP2019/014051 filed on Mar. 29, 2019, claiming priority based on Japanese Patent Application No. 2018-068481 filed Mar. 30, 2018, the disclosure of which is incorporated herein in its entirely by reference.

### FIELD

### Background

In non-intrusive load monitoring for example, detection of an operating rate, anomaly or a sign of anomaly of a facility is performed by sensing with a measurement apparatus (a sensor) or the like a signal waveform (e.g., current, voltage, or power waveform or in some cases at least one of mechanical vibration waveform, temperature, audio, etc.) of a manufacturing apparatus, an automatic vending machine, or the like and by monitoring sensing data. In this case, time-series data of a power supply current, power or the like when the facility is operated normally is acquired in advance via a sensor device, and a model about an operation state of the facility is learned or stored (e.g., a statistical model such as about fluctuation of time-series data, a stochastic transition model such as a hidden Markov model (HHM), or a machine learning model such as a classifier). When the facility is monitored, whether time-series data such as about the power supply current or power newly obtained from the sensor indicates anomaly or the like is determined based on the model.

A manufacturing apparatus (manufacturing facility) in a manufacturing industry, automatic vending machine or the like among apparatuses to be measured (apparatus under measurement) has a standby state or in some cases intermittently operates. There are

Substitute Specification (clean-up version) manufacturing apparatuses that operate only sometimes. When measurement data such as power consumption data (current consumption data, etc.) is continuously acquired (collected) from this kind of apparatus under measurement, for example, 24 hours a day, 365 days throughout a year, measurement data in a standby state that is not effective to grasp an operation state or detect anomaly is also collected. In this case, an amount of data accumulated in a storage apparatus is enlarged, and data traffic in a corresponding communication network is increased to press a band of the communication network.

In relation to a method in which data is accumulated based on trigger detection or the like instead of accumulating all data, for example, a dashboard camera method is known (e.g., see PTLs 1 and 2).

PTL 1 discloses a dashboard camera that performs control processing for recording information (image information) relating to occurrence of a predetermined event in recording means (a non-volatile memory) when acceleration sensor information matches a predetermined event occurrence determination pattern.

PTL 2 discloses a configuration in which data sensed by an acceleration sensor is compared with a threshold. When the sensed data exceeds the threshold, a trigger signal for starting storage of image information in a non-volatile memory is outputted.

FIG. 1 schematically illustrates a configuration of an apparatus (a system) of a related technique such as PTL 1 or 2. In FIG. 1, a threshold generation part 304 receives acceleration data (state information) detected by an acceleration sensor 306 and sets a threshold in advance. In this apparatus (system) 300 in FIG. 1, a dotted line arrow between elements represents a flow of preparation processing, and a solid line arrow between elements represents a flow of processing during actual operation. However, an individual arrow does not as a matter of course signify that data, a control signal, or the like between the corresponding elements flows only in one direction (the direction indicated by the arrow).

In FIG. 1, a certain short time of video data from an imaging camera 301 is sequentially and continuously stored and erased in a temporary storage memory part 302. The temporary storage memory part 302 is configured by, for example, a ring buffer (also referred to as a circular buffer).

A storage start determination part 305 receives acceleration data detected by the acceleration sensor 306. For example, when a predetermined event occurs, e.g., when the acceleration data exceeds a preset threshold, the storage start determination part 305 activates and outputs a storage start signal to the temporary storage memory part 302.

The temporary storage memory part 302 forwards data (video data) that has been held therein before activation of the storage start signal to a non-volatile memory part 303 and stores the data in the non-volatile memory part 303. The temporary storage memory part 302 also forwards data during as from the activation of the storage start signal until an elapse of a predetermined time to the non-volatile memory part 303 to store the data therein. When the data is forwarded from the temporary storage memory part 302, for example, the data reading and data forwarding from the temporary storage memory part 302 and the data writing in the non-volatile memory part 303 may be controlled via a controller or the like not illustrated. The temporary storage memory part 302 may include a semiconductor memory such as a DRAM (Dynamic Random Access Memory), a SRAM (Static RAM), or an EEPROM (Electrically Erasable And Programmable Read-Only Memory). The non-volatile memory part 303 may be an EEPROM, a USB (Universal

Serial Bus) memory, a HDD (Hard Disk Drive), or the like. In FIG. 1, if the acceleration sensor 306 is assumed to be a detection apparatus (a sensor) that detects an apparatus state, the acceleration data is state information. Thus, in FIG. 1, the acceleration sensor 306 is also denoted as (state detection apparatus), and the acceleration data is also denoted as (state information).

PTL 1: Japanese Unexamined Patent Application Publication No. 2012-64126

PTL 2: Japanese Patent No. 4238293

### SUMMARY

According to the related technique described with reference to FIG. 1, as a configuration to control an operation in the storage parts (the temporary storage memory part 302, etc.), a state detection apparatus for detecting a state of a target (such as the acceleration sensor 306 that detect another kind of a signal different from video data) is separately required other than a data path from the measurement part (e.g., the imaging camera 301) to the storage part, which results in high cost.

Accordingly, it is an object of the present invention to provide an apparatus, a method, a program, and a recording medium, each enabled to eliminate a need, in controlling an operation in a storage part which stores data, to additionally arrange a specific apparatus for detecting a state of a target, other than said data.

According to an aspect of the present invention, there is provided a data storage apparatus includes: a first storage part; a second storage part; and a determination part that determines whether at least a part of a first data block stored in the first storage part satisfies a predetermined first criterion, wherein, when the at least a part of the first data block stored in the first storage part satisfies the predetermined first criterion, the determination part causes the first storage part to forward the first data block stored in the first storage part to the second storage part to store the first data block therein, and causes the first storage part to forward a predetermined number of data blocks after the first data block stored in the first storage part to the second storage part to store the predetermined number of data blocks therein, and wherein, when there is data that satisfies a predetermined second criterion in the data blocks of from the first to the predetermined number, the determination part causes the first storage part to continue to store data blocks following the data block corresponding to the predetermined number and stored in the first storage part in the second storage part, while when there is no data that satisfies the predetermined second criterion in the data blocks of from the first to the predetermined number, the determination part causes the first storage part to stop storing a data block stored in the first storage part in the second storage part.

According to an aspect of the present invention, there is provide a data storage method, comprising:

forwarding, when at least a part of a first data block stored in a first storage part satisfies a predetermined first criterion, the first data block to a second storage part to store the first data block therein, and forwarding a predetermined number of data blocks after the first data block stored in the first storage part to the second storage part to store the predetermined number of data blocks therein;

continuing, when there is data that satisfies a predetermined second criterion in the data blocks of from the first to the predetermined number, to store data blocks following the data block corresponding to the predetermined number and stored in the first storage part in the second storage part; and

stopping, when there is no data that satisfies the second criterion in the data blocks of from the first to the predetermined number, storing a data block stored in the first storage part in the second storage part.

According to an aspect of the present invention, there is provided a program, causing a computer to perform processing comprising:

forwarding, when at least a part of a first data block stored in a first storage part satisfies a predetermined first criterion, the first data block to a second storage part to store the first data block therein, and forwarding a predetermined number of data blocks after the first data block stored in the first storage part to the second storage part to store the predetermined number of data blocks therein;

continuing, when there is data that satisfies a predetermined second criterion in the data blocks of from the first to the predetermined number, to store data blocks following the data block corresponding to the predetermined number and stored in the first storage part in the second storage part; and

stopping, when there is no data that satisfies the second criterion in the data blocks of from the first to the predetermined number, storing a data block stored in the first storage part in the second storage part. According to the present invention, there is provided a non-transitory computer-readable recording medium such as a computer-readable recording medium holding the above program, such as a semiconductor memory (e.g., a RAM, a ROM (Read-Only Memory), or an EEPROM), an HDD, a CD(Compact Disc), and a DVD (Digital Versatile Disc).

The present invention makes it possible to eliminate a need, in controlling an operation in a storage part which stores data, to additionally arrange a specific apparatus for detecting a state of a target, other than said data. Still other features and advantages of the present invention will become readily apparent to those skilled in this art from the following detailed description in conjunction with the accompanying drawings where only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram illustrating a related technique.

FIG. 2 is a diagram illustrating a basic mode of the present invention.

FIG. 3 is a diagram illustrating an arrangement of example embodiment 1 of the present invention.

FIG. 4 is a diagram illustrating an operation of example embodiment 1 of the present invention.

FIG. 5 is a diagram illustrating processing of example embodiment 1 of the present invention.

FIG. 6 is a diagram illustrating an arrangement of example embodiment 2 of the present invention.

FIG. 7 is a diagram illustrating an operation of example embodiment 2 of the present invention.

FIG. 8 is a diagram illustrating example embodiment 3 of the present invention.

FIG. 9 is a diagram illustrating example embodiment 4 of the present invention.

### DETAILED DESCRIPTION

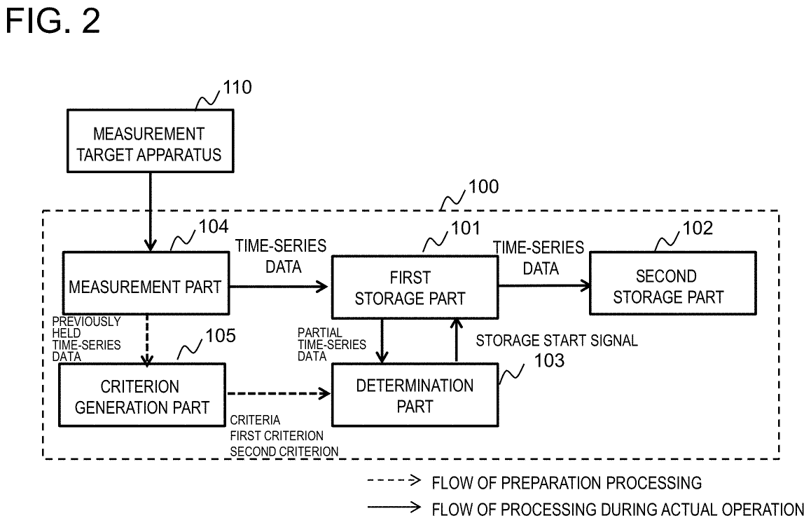

FIG. 2 is a diagram illustrating one mode of the present invention. As illustrated in FIG. 2, a data storage apparatus (system) 100 of the one mode of the present invention includes a first storage part 101, a second storage part 102, a determination part 103, a measurement part 104 that measures a signal of an apparatus to be measured (apparatus under measurement) 110, and a criterion generation part 105. For example, the apparatus under measurement 110 may be a manufacturing apparatus (facility) or an automatic vending machine (though not limited thereto). The measurement part 104 measures (samples at a predetermined frequency), for example, power consumption and/or current consumption of the apparatus under measurement 110, converts an analog signal waveform of the power consumption and/or current consumption into digital data, and outputs resultant measurement data (time-series data). The power consumption may be an effective power or an average value in a predetermined period, for example. For example, the current consumption may be a RMS (root mean square) value or an average value, instead of using an instantaneous current.

The criterion generation part 105 generates a first criterion based on measurement data held in advance (time-series data) acquired from the measurement part 104. The criterion generation part 105 further generates a second criterion based on the time-series data held in advance. In FIG. 2, a dotted line arrow between elements represents a flow of preparation processing, and a solid line arrow between elements represents a flow of processing during an actual operation. However, an individual arrow does not, as a matter of course, signify that data, a control signal, or the like between the corresponding elements flows only in one direction (the direction indicated by the arrow).

The determination part 103 collates at least a part of partial time-series data that is stored in the first storage part 101 and that is the same kind of data as the time-series data held in advance, with the first criterion to determine whether to store the time-series data stored in the first storage part 101 in the second storage part 102. For example, when at least a part of the time-series data stored in the first storage part 101 satisfies the first criterion, the determination part 103 causes the first storage part 101 to forward a first data block of the time-series data stored in the first storage part 101 to the second storage part 102 to store the first data block therein.

When the determination part 103 determines to perform storing time-series data stored in the first storage part 101 in the second storage part 102, the determination part 103 transmits a storage start signal to the first storage part 101. In this case, the determination part 103 is equipped with the storage start signal as a control signal which is connected from the determination part 103 to the first storage part 101. When determining to perform storing in the second storage part 102, the determination part 103 may activate the storage start signal and supply the activated storage start signal to the first storage part 101.

When the first storage part 101 receives the storage start signal (activated storage start signal), the first storage part 101 performs an operation to store time-series data held in the first storage part 101 in the second storage part 102.

The determination part 103 collates a part or all of partial time-series data that is stored in the first storage part 101 and that is the same kind of data as the time-series data held in advance, with the second criterion to determine whether to continue to store the time-series data in the second storage part 102. For example, when there is data that satisfies the second criterion from the first data block to a data block corresponding to a predetermined number out of the time-series data stored in the first storage part 101, the determination part 103 may continue to store the time-series data in the second storage part 102.

The first criterion and the second criterion may be specific values of the time-series data of the measured signals measured by the measurement part 104. For example, when a temporal transition from a small vale to a large value of a measured signal is to be detected, the second criterion is set to be a larger value than the first criterion.

The second criterion may be an index value of a likelihood as to whether the partial time-series data is the same as or similar to the time-series data held in advance. The index value of the likelihood may be a value obtained by entering the partial time-series data to a model generated by using the time-series data held in advance.

It is noted that in FIG. 2, individual parts of the data storage apparatus 100 may be implemented on a single unit. Alternatively, some or all of the parts may be disposed separately and connected to each other via communication means. For example, in the data storage apparatus 100, the measurement part 104 may be connected to the first storage part 101 and the criterion generation part 105 via a communication network. Alternatively, in view of an apparatus configuration, the first storage part 101 may be configured to constitute a part of the second storage part 102, as a separate partition arranged in the second storage part 102.

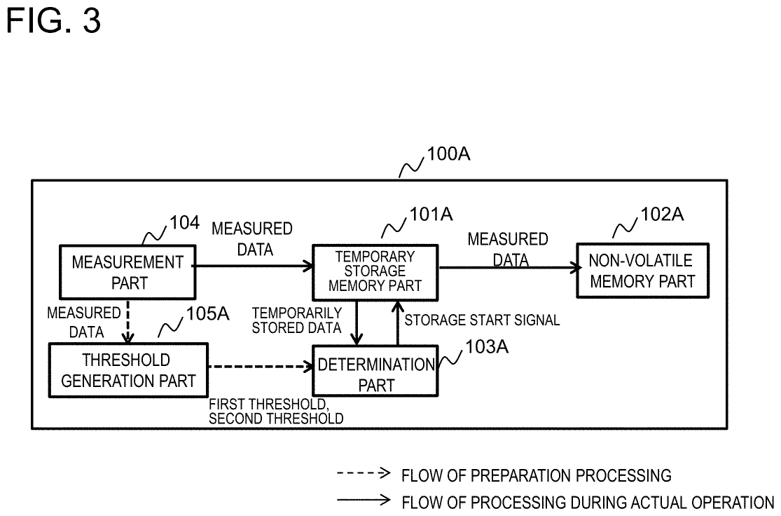

FIG. 3 is a diagram illustrating example embodiment 1 of the present invention. As illustrated in FIG. 3, a data storage apparatus (system) 100A includes a temporary storage memory part 101A, a non-volatile memory part 102A, a determination part 103A, a measurement part 104, and a threshold generation part 105A. The temporary storage memory part 101A, the non-volatile memory part 102A, the determination part 103A, and the threshold generation part 105A correspond to the first storage part 101, the second storage part 102, the determination part 103, and the criterion generation part 105 in FIG. 2, respectively.

The present description assumes that the measurement part 104 measures the power consumption of the apparatus under measurement 110 (see FIG. 2) (however, measurement is not limited to the power consumption as described above).

The threshold generation part 105A generates a first threshold (corresponding to the first criterion in FIG. 2) based on measurement data (time-series data) obtained in advance from the measurement part 104. In addition, the threshold generation part 105A generates a second threshold based on the measurement data from measurement part 104.

The determination part 103A collates a part or all of the measurement data stored in the temporary storage memory part 101A with the first threshold and determines whether to store the data (measurement data) temporarily stored in the temporary storage memory part 101A in the non-volatile memory part 102A.

When the determination part 103A determines that the data needs to be stored in the non-volatile memory part 102A, the determination part 103A transmits a storage start signal to the temporary storage memory part 101A. In this case, the determination part 103A has a storage start signal as a control signal connected from the determination part 103A to the temporary storage memory part 101A. When the determination part 103A determines that the data needs to be stored in the non-volatile memory part 102A, the determination part 103A may activate and supply the storage start signal to the temporary storage memory part 101A.

On reception of the activated storage start signal from the determination part 103A, the temporary storage memory part 101A reads the data (measurement data) held therein, and forwards the read data, to perform storing of the data in the non-volatile memory part 102A. When the data is forwarded from the temporary storage memory part 101A, for example, the data reading and data forwarding from the temporary storage memory part 101A and the data writing in the non-volatile memory part 102A may be controlled via a controller or the like not illustrated. The temporary storage memory part 101A may be configured as a buffer memory that after the data is read and forwarded to the non-volatile memory part 102A, a memory area in which the data has been stored can be overwritten with new data (measurement data).

Next, the determination part 103A collates a part or all of the measurement data stored in the temporary storage memory part 101A with the second threshold to determine whether to continue to store the measurement data in the non-volatile memory part 102A. In this case, the measurement data is power consumption. Since the determination part 103A determines a transition of the magnitude level (transition within a predetermined number of data blocks (frames)), the second threshold is larger than the first threshold.

When the data stored in the temporary storage memory part 101A exceeds the second threshold, the determination part 103A continues to store the data stored in the temporary storage memory part 101A in the non-volatile memory part 102A. When the data does not exceed the second threshold, the determination part 103A stops storing data in the non-volatile memory part 102A. The determination part 103A may deactivate the storage start signal supplied to the temporary storage memory part 101A, which responsive to a transition to the deactivated state of the storage start signal, stops forwarding a data block stored in the temporary storage memory part 101A to the non-volatile memory part 102A to stop storing the data block therein. The temporary storage memory part 101A may include a semiconductor memory such as a DRAM (Dynamic Random Access Memory), a SRAM (Static RAM), or an EEPROM (Electrically Erasable And Programmable Read-Only Memory). The non-volatile memory part 102A may include an EEPROM, a USB (Universal Serial Bus) memory, a HDD (Hard Disk Drive), or the like.

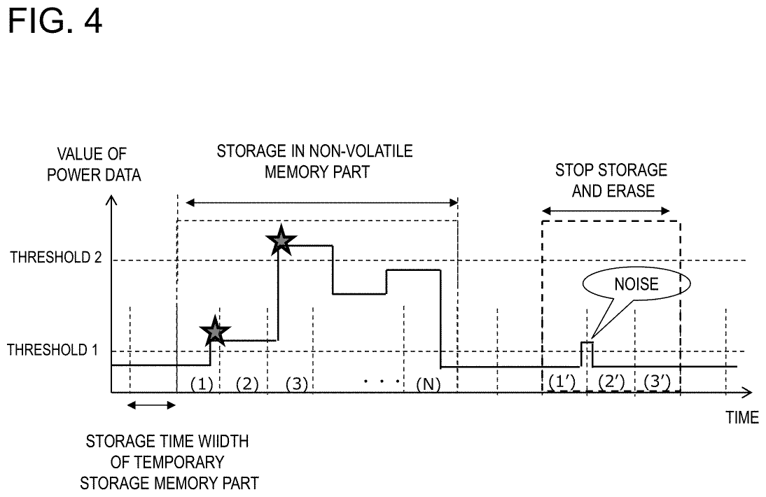

FIG. 4 is a diagram illustrating an operation of example embodiment 1. The determination part 103A collates a part of all of the measurement data stored in the temporary storage memory part 101A with the first threshold. If at least a part of the data exceeds the first threshold (threshold 1) (see a star mark in frame (1) in FIG. 4), the determination part 103A activates and transmits the storage start signal to the temporary storage memory part 101A in order to start to store the measurement data stored in the temporary storage memory part 101A in the non-volatile memory part 102A.

On reception of the activated storage start signal from the determination part 103A, the temporary storage memory part 101A starts to store the frame data (frame (1) in FIG. 4) stored at the time of the reception of the storage start signal in the non-volatile memory part 102A.

The temporary storage memory part 101A stores the frame data (frame (2) in FIG. 4) stored in the temporary storage memory part 101A in the non-volatile memory part 102A.

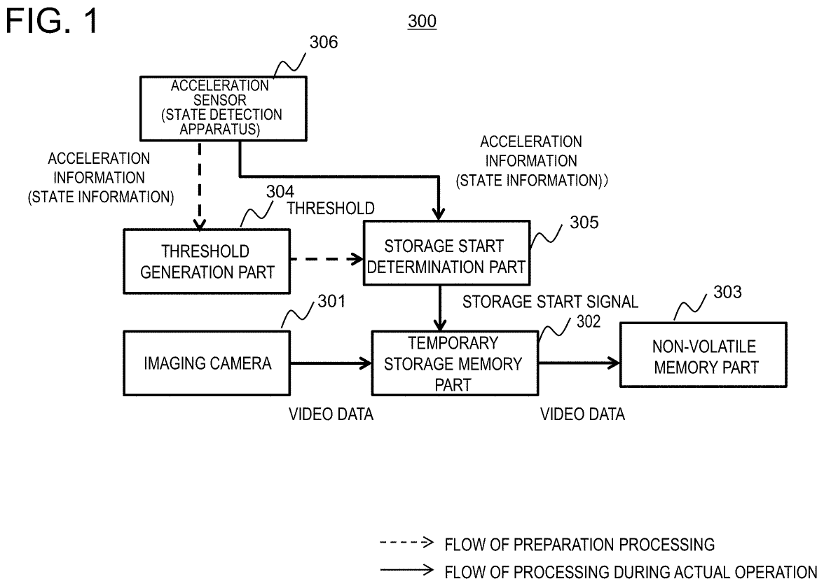

When there is data that exceeds the second threshold (threshold 3) within a predetermined number of frames (e.g., three frames) after the storage in the non-volatile memory part 102A is started, the determination part 103A determines to continue to store the frame data stored in the temporary storage memory part 101A (frame data after frame (3) in FIG. 4) in the non-volatile memory part 102A. In this case, data up to frame N stored in the temporary storage memory part 101A are stored in the non-volatile memory part 102A. Any method may be used to set this N (there is no particular limitation such as storing until a predetermined time elapses as from an activation of the storage start signal in FIG. 1″).

On the other hand, even when at least a part of the frame data stored in the temporary storage memory part 101A exceeds the first threshold, if there is no data that exceeds the second threshold (threshold 2) by the third frame, the determination part 103A determines that the data exceeding the first threshold is a noise and stops storing data in the non-volatile memory part 102A. In the example in FIG. 4, since the measurement data in frame (1′) stored in the temporary storage memory part 101A exceeds the first threshold (threshold 1), the temporary storage memory part 101A forwards and stores frames (1′) to (3′) in the non-volatile memory part 102A. However, since the frame (1′) to the third frame does not exceed the second threshold (threshold 2), frames (1′) to (3′) stored in the non-volatile memory part 102A are erased. Thus, erroneous storage of data in the non-volatile memory part 102A due to noise does not occur.

The frame data in the temporary storage memory part 101A is a data block with a fixed length, which is a storage unit of the temporary storage memory part 101A. The data block size (data length) may be a data transmission unit of a communication protocol among the measurement part 104, the temporary storage memory part 101A, and the non-volatile memory part 102A. Alternatively, the data block may have a size (data length) obtained by combining a plurality of data transmission units among the measurement part 104, the temporary storage memory part 101A, and the non-volatile memory part 102A. In this case, the data block is divided into each size of the data transmission unit and is forwarded a plurality of times.

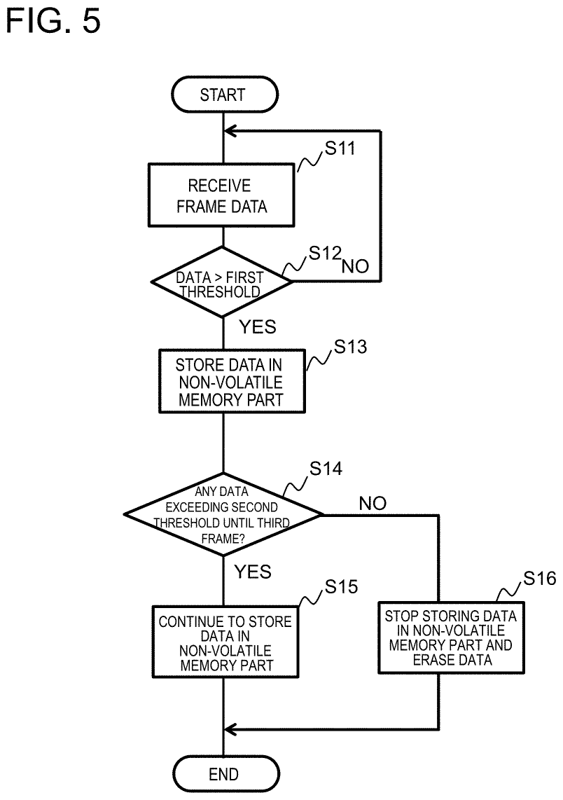

FIG. 5 is a diagram illustrating control performed by the determination part 103A in example embodiment 1. The determination part 103A receives frame data stored in the temporary storage memory part 101A (S11). If a part of the data exceeds the first threshold (threshold 1) (YES in S12), the frame data is stored in the non-volatile memory part 102A. The data until the third frame stored in the temporary storage memory part 101A is stored in the non-volatile memory part 102A. If any frame until the third frame (e.g., any one of the first to third frames) exceeds the second threshold (threshold 2) (YES in S14), the frame data (the fourth and subsequent frame data) stored in the temporary storage memory part 101A is continuously stored in the non-volatile memory part 102A (S15). In contrast, even if the measurement data stored in the temporary storage memory part 101A has exceeded the first threshold (threshold 1), if data does not exceed the second threshold (threshold 2) up to the third frame, the storage in the non-volatile memory part 102A is stopped, and the data from the first to third frames stored in the non-volatile memory part 102A is erased.

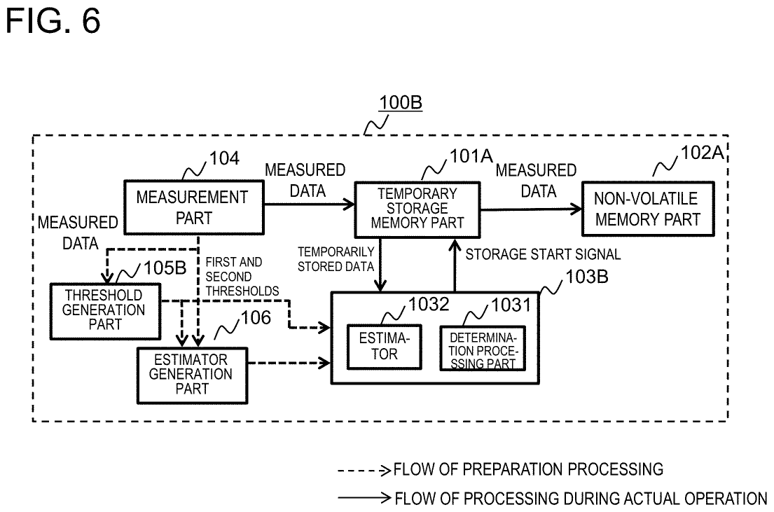

FIG. 6 is a diagram illustrating example embodiment 2 of the present invention. As illustrated in FIG. 6, a data storage apparatus (system) 100B includes a temporary storage memory part 101A, a non-volatile memory part 102A, a determination part 103B, a measurement part 104, a threshold generation part 105B, and an estimator generation part 106. The temporary storage memory part 101A, the non-volatile memory part 102A, and the threshold generation part 105B correspond to the temporary storage memory part 101A, the non-volatile memory part 102A, and the threshold generation part 105A in FIG. 3, respectively. The threshold generation part 105B may generate and supply first and second thresholds to the estimator generation part 106 and supply only the first threshold to the determination part 103B.

Based on measurement data supplied from the measurement part 104, the estimator generation part 106 learns a model for measurement data in which the measurement data is estimated to exceed the second threshold within a period up to a predetermined frame (e.g., the third frame) after exceeding the first threshold. Supervised learning such as SVM (Support Vector Machine), a Naive Bayes classifier, or a decision tree or a clustering method such as K-means may be used for this model.

The determination part 103B includes an estimator 1032 and a determination processing part 1031. The estimator 1032 receives frame data stored in the temporary storage memory part 101A and supplies, as a second criterion, an index of likelihood that at least a part of the data is the same as or similar to predetermined time-series data to the determination processing part 1031.

When any of the frame data stored in the temporary storage memory part 101A exceeds the first threshold generated by the threshold generation part 105B, the determination processing part 1031 activates and supplies a storage start signal to the temporary storage memory part 101A. At the same time, the estimator 1032 estimates an index of likelihood that the frame data stored in the temporary storage memory part 101A is the same as or similar to predetermined time-series data (time-series data that exceeds the second threshold from the said frame to the third frame) and outputs the likelihood or the like.

Based on the output from the estimator 1032, the determination processing part 1031 determines whether to store the frame data stored in the temporary storage memory part 101A in the non-volatile memory part 102A and performs control to continue or stop storing data from the temporary storage memory part 101A to the non-volatile memory part 102A. When the estimation result of the index of likelihood that the data is the same as or similar to the predetermined time-series data satisfies a predetermined condition (i.e., the second criterion is satisfied), the determination processing part 1031 causes the temporary storage memory part 101A to continue to store data in the non-volatile memory part 102A. When the estimation result of the index of likelihood that the data is the same as or similar to the predetermined time-series data does not satisfy the predetermined condition (i.e., the second criterion is not satisfied), the determination processing part 1031 causes the temporary storage memory part 101A to stop storing data in the non-volatile memory part 102A and to erase the data of the three frames stored in the non-volatile memory part 102A.

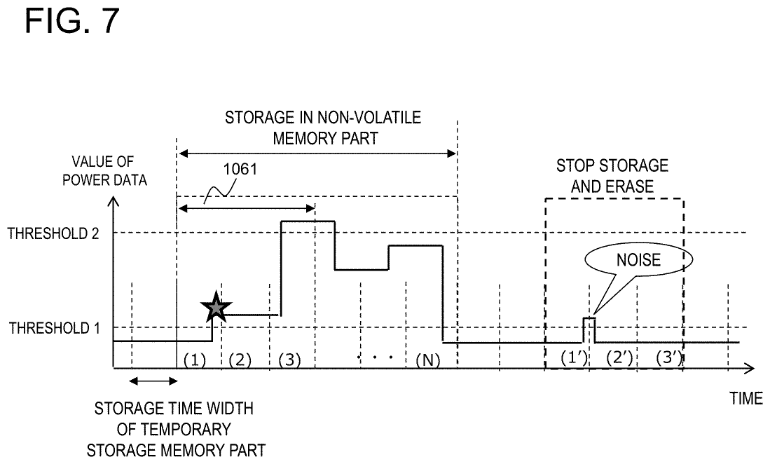

FIG. 7 is a diagram illustrating an operation of example embodiment 2 of the present invention. Among frame data stored in the temporary storage memory part 101A, frame (1) exceeds the first threshold (threshold 1). Based on the estimation result of the estimator 1032 that receives frame data stored in the temporary storage memory part 101A, if the determination processing part 1031 estimates (classifies) that the second threshold (threshold 2) will be exceeded with an overwhelming likelihood by the data of frame (3) stored in the temporary storage memory part 101A (within a time interval 1061), the determination processing part 1031 performs control processing so that subsequent frames will be stored in the non-volatile memory part 102A. On the other hand, while frame (1′) exceeds the first threshold (threshold 1) among the frame data stored in the temporary storage memory part 101A, if the determination processing part 1031 estimates (classifies) that the second threshold (threshold 2) is not satisfied (the second threshold is not exceeded) by frame (3′) as a result of the estimation by the estimator 1032 that receives frame data stored in the temporary storage memory part 101A, the determination processing part 1031 stops storing data in the non-volatile memory part 102A and erases frames (1′) to (3′) stored in the non-volatile memory part 102A.

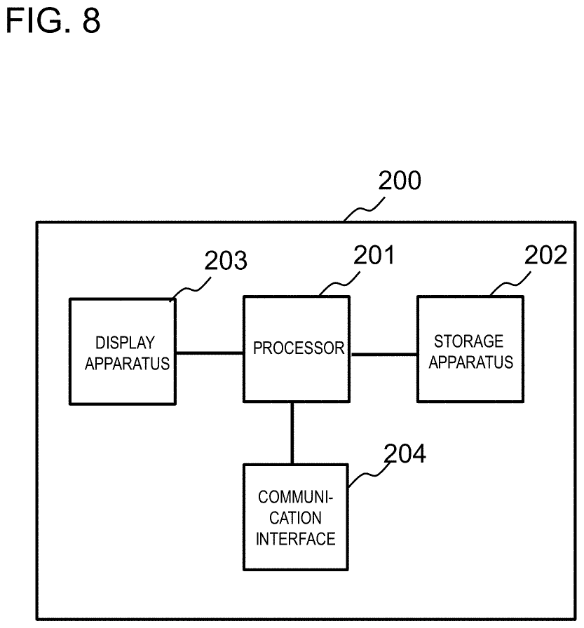

In an example embodiment 3, as schematically illustrated in FIG. 8, the determination part 103, the criterion generation part 105, the first storage part 101, and the second storage part 102 of the data storage apparatus 100 may be implemented by a program that operates on a computer apparatus 200. As illustrated in FIG. 8, a computer apparatus 200 includes a processor 201, a storage apparatus 202 including at least one of a semiconductor memory (e.g., a RAM, a ROM, an EEPROM, or the like), an HDD, a CD, a DVD, etc., a display apparatus 203, and a communication interface 204. The communication interface 204 may be configured to communicate with the measurement part 104. The functions of the data storage apparatuses 100, 100A, or 100B according to the respective example embodiment may be realized by storing, for example, a program that realizes the processing of the determination part 103, 103A, or 103B, the criterion generation part 105, the threshold generation part 105A or 105B, and the estimator generation part 106 of the data storage apparatus 100 in the storage apparatus 202 and by causing the processor 201 to read and execute the program. The storage apparatus 202 may be configured to include the first storage part 101 and the second storage part 102.

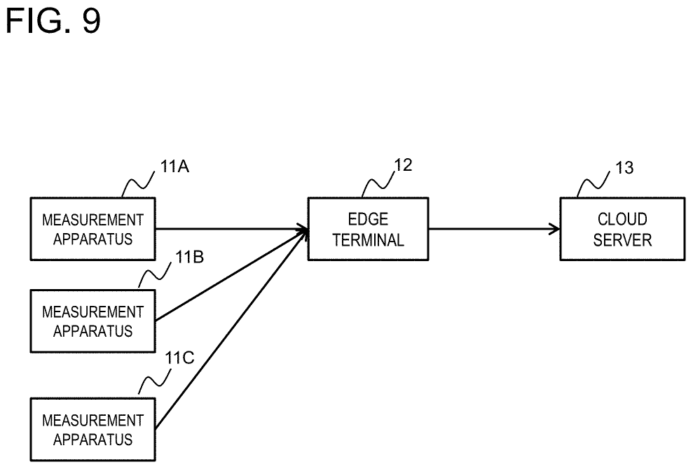

FIG. 9 is a diagram illustrating example embodiment 4 of the present invention. In Internet of Things (IoT), for example, data is collected from sensors mounted on things, and for example, the data is analyzed by a cloud server or the like. It is becoming impossible for such a cloud server to process all the data of the IoT devices such as sensors in terms of processing performance, communication band width, etc. Thus, there has been used a mode in which an edge apparatus (an edge node, an edge terminal) executes processing of data to some extent and forwards the processed data to the cloud side. For example, an individual measurement apparatus 11 may be an IoT apparatus having a sensing function to measure power consumption, current consumption, or the like of a manufacturing apparatus (facility) or the like and a communication function to perform wired or wireless transmission of measurement data. The individual measurement apparatus 11 transmits the measurement data to a cloud server 13 via an edge apparatus 12 through a communication network. The communication network may be, for example, a wired LAN (Local Area Network) such as Ethernet (registered trademark), Wi-Fi (registered trademark), a wireless LAN such as Bluetooth (registered trademark), a carrier communication network (a mobile communication network), or a WAN (Wide Area Network) such as the Internet. The edge apparatus 12 performs processing of the measurement data transmitted from the measurement apparatuses 11 and destined to the cloud server 13 to some extent and forwards the processed data to the cloud server 13. The cloud server 13 may receive the measurement data (e.g., the time-series data of composite power consumption or composite current consumption of a plurality of electrical devices or facilities) from individual measurement apparatuses 11, perform waveform disaggregation processing for disaggregating the measurement data into the time-series data (waveforms) of power consumption or current consumption of the individual electrical device to estimate a state of the individual electrical device.

The edge apparatus 12 may be an edge terminal, an edge router, an edge switch, an edge server, an edge gateway, a mobility edge computing (MEC) server, or the like. When measurement data of a manufacturing facility is collected and analyzed, the edge apparatus 12 may be a gateway or the like such as a factory energy management system (FEMS). In this communication network system, the measurement apparatus 11 may be provided with the data storage apparatus 100 (100A, 100B) according to the above described example embodiments, and the measurement data forwarded from the first storage part 101 and stored in the second storage part 102 may be forwarded to the edge apparatus 12 via a communication network. Alternatively, the edge apparatus 12 may be provided with the data storage apparatus 100 (100A, 100B) according to the above described example embodiments, and the measurement data stored in the second storage part 102 may be forwarded to the cloud server 13. In this way, it is made possible to avoid unnecessary data forwarding through the communication network, and to allow effective use of the network bandwidth. The measurement data obtained by the measurement part 104 may be current, voltage, power waveform, mechanical vibration waveform, temperature, audio, or the like.

The disclosure of each of the above PTLs 1 and 2, etc. that have been referred to is incorporated herein by reference thereto. Variations and adjustments of the example embodiments and examples are possible within the scope of the overall disclosure (including the claims) of the present invention and based on the basic technical concept of the present invention. Various combinations and selections of various disclosed elements (including the elements in each of the notes, example embodiments, examples, drawings, etc.) are possible within the scope of the overall disclosure of the present invention. Namely, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

What is claimed is:

1. A data storage apparatus, comprising:
a processor;
a memory storing program instructions executable by the processor;
a first storage part; and
a second storage part;
wherein the processor, when executing the program instructions stored in the memory, determines whether at least a part of a first data block stored in the first storage part satisfies a predetermined first criterion,
wherein, when the at least a part of the first data block stored in the first storage part satisfies the predetermined first criterion, the processor causes the first storage part to forward the first data block stored in the first storage part to the second storage part to store the first data block therein, and causes the first storage part to forward a predetermined number of data blocks after the first data block stored in the first storage part to the second storage part to store the predetermined number of data blocks therein, and
wherein, when finding that there is data that satisfies a predetermined second criterion in the data blocks of from the first to the predetermined number, the processor causes the first storage part to continue to forward data blocks following the data block corresponding to the predetermined number and stored in the first storage part to the second storage part to store the data blocks therein,
while when finding that there is no data that satisfies the predetermined second criterion in the data blocks of from the first to the predetermined number, the processor causes the first storage part to stop storing a data block stored in the first storage part in the second storage part.

2. The data storage apparatus according to claim 1, wherein when finding that there is no data that satisfies the second criterion in the data blocks of from the first to the predetermined number, the processor performs control to erase the first data block and the predetermined number of data blocks stored in the second storage part.

3. The data storage apparatus according to claim 1, wherein the processor is further configured to
generate the first criterion and the second criterion.

4. The data storage apparatus according to claim 1, wherein the first criterion and the second criterion are a first threshold and a second threshold corresponding to data values, respectively.

5. The data storage apparatus according to claim 1, wherein the second criterion is an index of likelihood that at least a part of the data from the first data block to the data block corresponding to the predetermined number is the same as or similar to predetermined time-series data.

6. The data storage apparatus according to claim 5, wherein the processor is configured to
generate an estimator that receives at least the first data block stored in the first storage part and estimates whether there is data that satisfies the second criterion in the data blocks of from the first to the predetermined number.

7. The data storage apparatus according to claim 1, wherein time-series data measured by a measurement part is stored in the first storage part.

8. The data storage apparatus according to claim 1, wherein the second storage part includes a non-volatile memory.

9. A data storage method, comprising:
forwarding, when at least a part of a first data block stored in a first storage part satisfies a predetermined first criterion, the first data block to a second storage part to store the first data block therein, and forwarding a predetermined number of data blocks after the first data block stored in the first storage part to the second storage part to store the predetermined number of data blocks therein;
continuing, when there is data that satisfies a predetermined second criterion in the data blocks of from the first to the predetermined number, to forward data blocks following the data block corresponding to the predetermined number and stored in the first storage part to the second storage part to store the data blocks therein; and
stopping, when there is no data that satisfies the second criterion in the data blocks of from the first to the predetermined number, storing a data block stored in the first storage part in the second storage part.

10. The data storage method according to claim 9, comprising
when there is no data that satisfies the second criterion in the data blocks of from the first to the predetermined number,
erasing the first data block and the predetermined number of data blocks stored in the second storage part.

11. The data storage method according to claim 9, wherein the first criterion and the second criterion are a first threshold and a second threshold corresponding to data values, respectively.

12. The data storage method according to claim 9, wherein the second criterion is an index of likelihood that at least a part of the data from the first data block to the data block corresponding to the predetermined number is the same as or similar to predetermined time-series data.

13. A non-transitory computer readable medium storing a program causing a computer to execute processing comprising:
forwarding, when at least a part of a first data block stored in a first storage part satisfies a predetermined first criterion, the first data block to a second storage part to store the first data block therein, and forwarding a predetermined number of data blocks after the first data block stored in the first storage part to the second storage part to store the predetermined number of data blocks therein;
continuing, when there is data that satisfies a predetermined second criterion in the data blocks of from the first to the predetermined number, to forward data blocks following the data block corresponding to the predetermined number and stored in the first storage part in the second storage part to store the data blocks therein; and
stopping, when there is no data that satisfies the second criterion in the data blocks of from the first to the predetermined number, storing the data blocks stored in the first storage part in the second storage part.

14. (canceled)

15. The data storage method according to claim 9, comprising
generating the first criterion and the second criterion.

16. The data storage method according to claim 12, comprising
generating an estimator that receives at least the first data block stored in the first storage part and estimates whether there is data that satisfies the second criterion in the data blocks of from the first to the predetermined number.

17. The data storage method according to claim 9, comprising
wherein, when there is no data that satisfies the second criterion in the data blocks of from the first to the predetermined number, erasing the first data block and the predetermined number of data blocks stored in the second storage part.

18. The non-transitory computer readable medium according to claim 13, storing the program causing the computer to execute processing comprising
when there is no data that satisfies the second criterion in the data blocks of from the first to the predetermined number,
erasing the first data block and the predetermined number of data blocks stored in the second storage part.

19. The non-transitory computer readable medium according to claim 13, storing the program causing the computer to execute processing comprising
generating the first criterion and the second criterion.

20. The non-transitory computer readable medium according to claim 13, wherein the first criterion and the second criterion are a first threshold and a second threshold corresponding to data values, respectively.

21. The non-transitory computer readable medium according to claim 13, storing the program causing the computer to execute processing comprising
generating an estimator that receives at least the first data block stored in the first storage part and estimates whether there is data that satisfies the second criterion in the data blocks of from the first to the predetermined number.
